(19) United States
(12) Patent Application Publication
(10) Pub. No.: US 2011/0234715 A1
(43) Pub. Date: Sep. 29, 2011

(54) LIQUID EJECTION HEAD AND LIQUID EJECTING APPARATUS

(75) Inventors: Takashi Tada, Matsumoto-shi (JP); Satoshi Oguchi, Okaya-shi (JP)

(73) Assignee: SEIKO EPSON CORPORATION, Shinjuku-ku (JP)

(21) Appl. No.: 13/069,340

(22) Filed: Mar. 22, 2011

(30) Foreign Application Priority Data
Mar. 23, 2010 (JP) 2010-067066

(51) Int. Cl. B41J 2/175

(52) U.S. Cl. 347/85

(57) ABSTRACT

Ink is transported to the transporting passage side by circulating the ink from inside to the outside of the coil spring. When foreign materials are mixed within ink, the foreign materials can be captured in the gaps of the windings of the coil spring.

### CROSS REFERENCE TO RELATED APPLICATION

The entire disclosure of Japanese Patent Application No. 2010-67066, filed Mar. 23, 2010, is expressly incorporated herein by reference.

### BACKGROUND

1. Technical Field

The present invention relates to a liquid ejecting head and a liquid ejecting apparatus.

2. Related Art

As disclosed in JP-A-2008-200996, a head main body of an ink jet type recording head includes a sealing apparatus that is opened/closed by a pressure change and circulates ink from a supply source when ink is ejected from a nozzle. Since ink is supplied when ink is ejected and a pressure of a flow passage of the nozzle side is lowered relatively with respect to the supply source side, ink can be uniformly ejected from the nozzle by providing the sealing apparatus.

A sealing apparatus in the related art has a configuration in which ink is circulated in a narrow gap by the opening/closing of the valve body. Thus, when the valve body is closed in a state that foreign materials are mixed within ink, there is a concern that the foreign materials are interposed between the valve body and a seating face so that ink may be leaked to the downstream side. Since ink that is transported to the sealing apparatus passes through a filter, the foreign materials that are mixed in ink between the supply source and the sealing apparatus can be captured, however the foreign materials being entered within the sealing apparatus may be considered.

### SUMMARY

According to an aspect of the invention, there is provided a liquid ejecting head including: a sealing apparatus and a head main body, wherein the sealing apparatus includes a valve body that opens/closes a flow passage in which liquid is circulated, a biasing member that is arranged in the upstream side of the flow passage and biases the valve body toward a closing side, and a pressure member that pinches the valve body and opens/closes the valve body according to a change of a liquid pressure difference between the flow passage of the upstream side and the flow passage of a downstream side, wherein the biasing member includes a circulation passage that circulates the liquid being circulated to the downstream side of the flow passage and simultaneously captures foreign materials, and wherein the head main body includes a nozzle opening that ejects liquid that is transported from the flow passage of the downstream side of the sealing apparatus.

According to another aspect of the invention, there is provided a liquid ejecting apparatus including the above-described liquid ejecting head.

### BRIEF DESCRIPTION OF THE DRAWINGS

The invention will be described with reference to the accompanying drawings, wherein like numbers reference like elements.

FIG. 1 is a schematic configuration view illustrating an ink jet type recording apparatus of the invention.

FIG. 2 is a side-elevation view illustrating an ink ejecting head of the invention.

FIG. 3 is a cross-sectional view taken along an arrow line III-III in FIG. 2.

FIG. 4 is an external view of a protrusion member according to the invention.

FIG. 5 is an external view of a cylindrical wall according to the invention.

### DESCRIPTION OF EXEMPLARY EMBODIMENTS

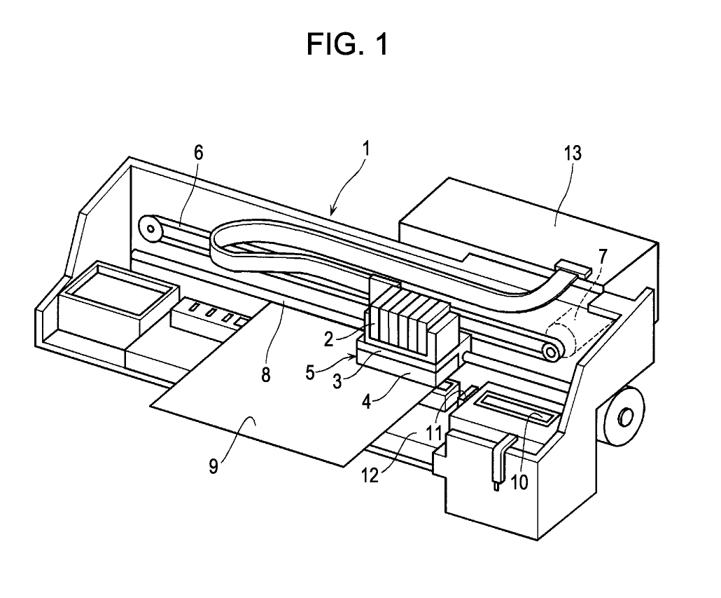

Description will be given regarding the ink jet type recording apparatus based on FIG. 1. FIG. 1 schematically illustrates overall configuration of the ink jet type recording apparatus.

As shown in the drawing, the ink jet type recording apparatus (an apparatus main body) 1 as a liquid ejecting apparatus has an ink ejecting head 5 as a head main body in which the carriage 3 on which the ink cartridge 2 is mounted, and a recording head 4 that is attached in the carriage 3 are integrally formed. The carriage 3 is connected to a stepping motor 7 through a timing belt 6 and guided with a guide bar 8 so as to reciprocate in a paper width direction (a main scanning direction) of a recording paper 9. The carriage 3 having a box shape that is opened at an upper portion is mounted so as to expose a nozzle surface of the recording head 4 to a surface (a lower surface) facing the recording paper 9, and the ink cartridge 2 is received therein.

Ink is supplied from the ink cartridge 2 to the recording head 4 (the ink ejecting head 5) and the ink droplets are ejected on an upper surface of a recording paper 9 while moving the carriage 3 so that an image or a letter is printed on the recording paper 9 by a dot matrix. Regarding reference numbers in FIG. 1, 10 is a cap in which the nozzle opening of the recording head 4 is sealed while the printing is paused so that the nozzle is prevented from being dried and a negative pressure is applied to the nozzle surface of the recording head 4 so that a cleaning operation is performed, 11 is a wiper blade that wipes the nozzle surface of the recording head 4, 12 is a waste ink reservoir that accommodates waste ink that is absorbed by a cleaning operation and 13 is a control apparatus that controls the operation of the apparatus main body 1.

In the ink ejecting head 5 shown in the drawing, a flow passage for ejecting the ink in the ink cartridge 2 from a nozzle opening is formed. The flow passage of ink is opened/closed by the sealing apparatus and by a pressure change according to the ejection of the ink, as described below in detail.

In the example of FIG. 1, an example is described in which the ink cartridge 2 as a liquid source is received in the carriage 3, the invention may be applied even in a configuration of the ink jet type recording apparatus in which the ink cartridge is received at a different position from the carriage 3 and the ink is transported in a pressurized manner to the recording head 4 through the supply pipe.

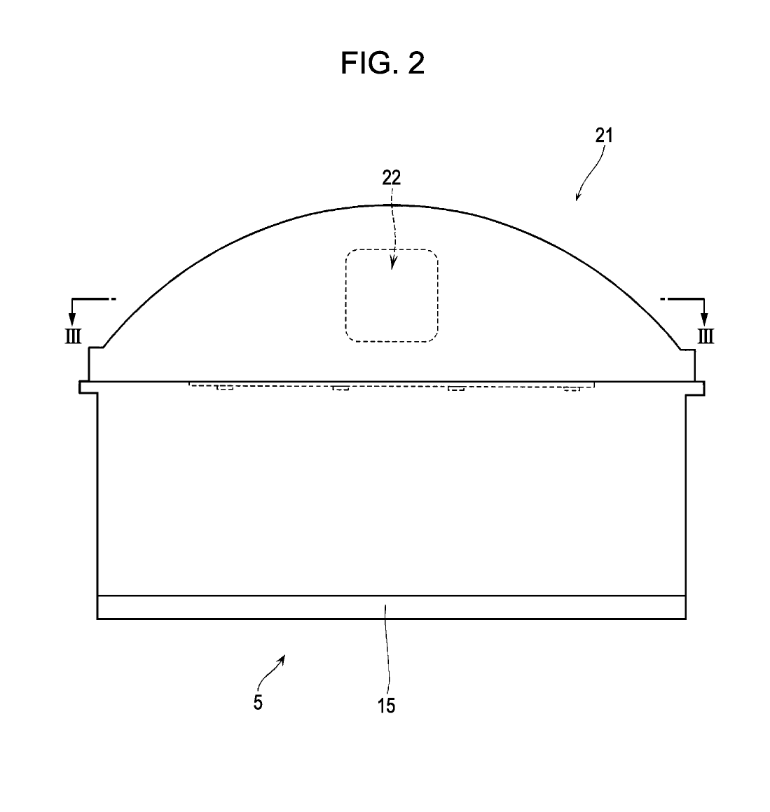

Description will be given regarding the ink ejecting head 5 on the basis of FIG. 2. FIG. 2 shows a side shape that illustrates the entire ink ejecting head.

As shown in the drawing, the ink ejecting head 5 includes a pressure generating unit such as a piezoelectric element, for example, and ink droplets are ejected from the nozzle opening of a nozzle plate 15 using the pressure according to the displacement of the piezoelectric element. The reservoir chamber is provided in the ink ejecting head 5 and a flow passage member 21 is fixed on the upper portion of the ink ejecting head 5. Ink in the form of liquid is supplied from the flow passage member 21 in a head flow passage of the ink ejecting head 5 and ink is transported from the head flow passage to the reservoir chamber.

Ink is supplied from the ink cartridge 2 in the flow passage member 21. For example, ink is supplied from the ink cartridge 2 to the flow passage member 21 through the supply pipe or an ink supply needle. In other words, the liquid ejecting head consists of the ink ejecting head 5 that is the head main body and the flow passage member 21.

When a sealing apparatus (self sealing valve) 22 is provided in the flow passage member 21 and the pressure of the ink in a downstream side is lowered (when becoming negative pressure) relatively with respect to an upstream side by the ejection of the ink, the flow passage is opened by the sealing apparatus 22 and then ink is supplied to the downstream side. Accordingly, ink more than the required amount of is not supplied to the downstream side and the ejection of the ink droplets from the nozzle opening of the nozzle plate 15 can be performed uniformly.

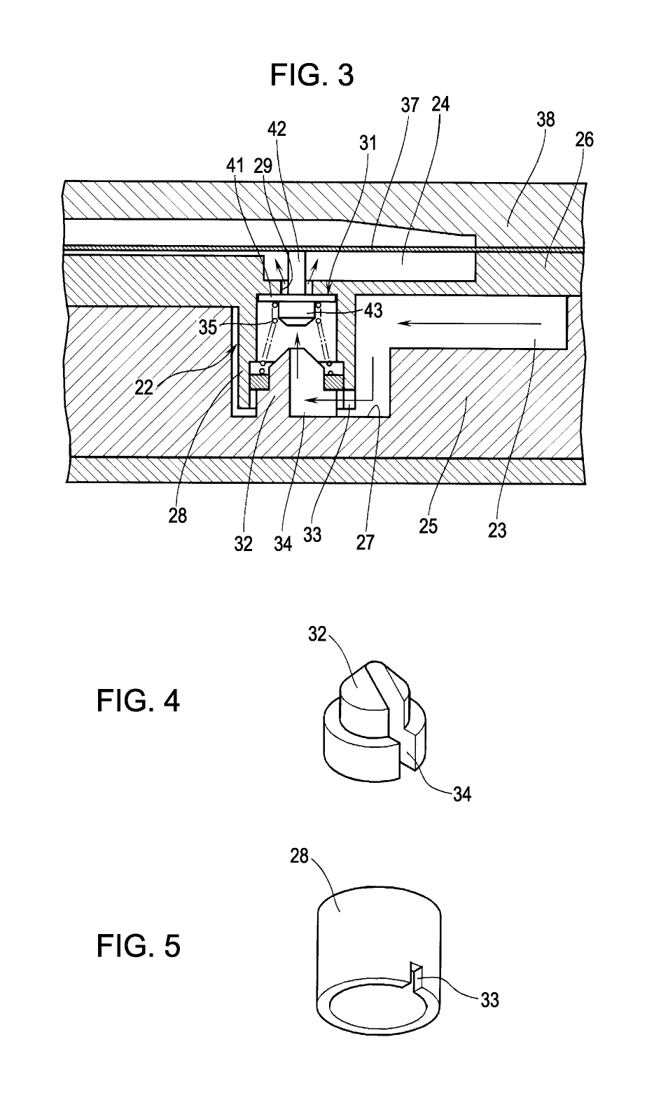

Detailed description will be given regarding the sealing apparatus 22 of the flow passage member 21 based on FIGS. 3 to 5. FIG. 3 illustrates a cross-sectional state (seen from the arrow line III-III in FIG. 2) of a portion of the sealing apparatus 22 of the ink ejecting head, FIG. 4 shows a perspective state illustrating the external of a protrusion member and FIG. 5 shows the perspective state illustrating the external of a cylindrical wall.

The flow passage member 21 has a block shape and forms an ink flow passage therein. Ink from the ink cartridge 2 (see FIG. 1) through a filter member (not shown) in the supply passage 23 that is a flow passage of the upstream side is supplied and ink is transported to the ink ejecting head 5 (see FIG. 2) side from a transporting passage 24 that is a flow passage of the downstream side.

When the sealing apparatus 22 is provided between the supply passage 23 and the transporting passage 24 and ink is ejected from the nozzle opening of the nozzle plate 15 (see FIG. 2) so that the transporting passage 24 comes to have a negative pressure, the flow passage of the sealing apparatus 22 is opened and then ink is supplied to the transporting passage 24 from the supply passage 23. When ink is supplied to the transporting passage 24 and the pressure of the transporting passage 24 is raised, the flow passage of the sealing apparatus 22 is closed and then the supply of the ink is stopped until the ink is ejected.

The supply passage 23 is formed by a first case 25 and a second case 26, and a recess section 27 is formed in the first case 25 at the downstream side of the supply passage 23. A cylindrical wall 28 (see FIG. 5) of the second case 26 is fitted to the recess section 27 of the first case 25 and an opening 29 is formed in the transporting passage 24 corresponding to a bottom section of the cylindrical wall 28. A valve body 31 is provided within the cylindrical wall 28 and the opening 29 is opened/closed by the valve body 31.

The transporting passage 24 is formed in the second case 26 opposite to the cylindrical wall 28 and a flexible sheet material 37 covers the transporting passage 24. When the periphery portion of the sheet material 37 is fixed to the second case 26 by the cover 38 and the pressure of the transporting passage 24 is lowered (when becoming negative pressure) relatively with respect to the pressure of the supply passage 23, the sheet material 37 is deformed toward the second case 26 side (the side that narrows the transporting passage 24).

The conical shaped protrusion member 32 (see FIG. 4) is formed at the bottom section of the recess section 27 of the first case 25, and the cylindrical wall 28 of the second case 26 is arranged in the state where the protrusion member 32 is covered, and a slit 33 (see FIG. 5: a circulation section) is provided at an end section of a bottom section side of the recess section 27 in the cylindrical wall 28. A slit groove 34 (see FIG. 4) that is extended in a height direction and extends to a center section in the side section of the protrusion member 32 is formed and the slit groove 34 is communicated with the slit 33.

In other words, as arrow shown in FIG. 3, ink that is transported from the supply passage 23 is guided to the lower-mid side in FIG. 3 at the outside of the cylindrical wall 28 and transported to the upper side of the protrusion member 32 through the slit groove 34 from the slit 33 (passage).

The valve body 31 is biased to the closing direction of the opening 29 from the recess section 27 side by a coil spring 35 serving as a bias member. The coil spring 35 is a conical shape of which a diameter in the axial direction is gradually decreased toward the valve body 31 side, the inside of the coil spring 35 at the lower side (the side where the diameter is thick) of FIG. 3, is fitted to the outside of the protrusion member 32. Also, the outside of the coil spring 35 in lower-mid side in FIG. 3 is defined by the inside surface of the cylindrical wall 28.

Accordingly, the coil spring 35 is easily positioned by the protrusion member 32 at the time of arrangement, the position is easily defined in the state where the lower side is pinched in the protrusion member 32 and the cylindrical wall 28, and the flexibility of the coil spring 35 can be maintained in a uniform state.

A seal base 41 that closes off the opening 29 from the recess section 27 side is provided in the valve body 31 and a downstream valve shaft 42 that penetrates the opening 29 and arranged in the downstream side (the transporting passage 24 side) of the seal base 41 is continuously formed. The downstream valve shaft 42 is penetrated and arranged the opening 29, and the sheet material 37 comes into contact with a tip end of the downstream valve shaft 42. An upstream valve shaft 43 is continuously formed in the upstream side (the protrusion member 32 side) of the seal base 41 and the upstream valve shaft 43 is fitted to the inside of the coil spring 35 at the upper side (the side that the diameter is decreased) in FIG. 3.

The valve body 31 is biased to the upper side in FIG. 3 by a biasing force of the coil spring 35 and the opening 29 is closed by the seal base 41 from the recess section 27 side in the above-described sealing apparatus 22. When the transporting passage 24 is made to have negative pressure by the ejection of the ink, the sheet material 37 is deformed toward the second case 26 side and a force that presses down the downstream valve shaft 42 in lower-mid direction in FIG. 3 is operated. According to the deformation of the sheet material 37, the valve body 31 is pressed down against the biasing force of the coil spring 35, the seal base 41 is separated from the opening 29 and ink can flow through the opening 29 so that ink is supplied to the transporting passage 24. In the state that ink is supplied to the transporting passage 24, the deformation of the sheet material 37 is released, the valve body 31 is biased by the biasing force of the coil spring 35 and then the opening 29 is closed off.

Ink that is supplied to the supply passage 23 from the ink cartridge 2 (see FIG. 1) through the filter member (not shown) is guided to the lower side in FIG. 3 at the outside of the cylindrical wall 28 and transported to the upper side of the protrusion member 32 through the slit groove 34 from the slit 33. Ink that passes through the slit groove 34 is all guided into the inside of the coil spring 35 and flows from the inside to the outside through gaps of windings. All of the ink is transported to the transporting passage 24 when the opening 29 is opened by the pressure change of the transporting passage 24.

Since all of the ink from the supply passage 23 is circulated to the gaps of the windings of the coil spring 35, the foreign materials are captured in the gaps of the windings even if the foreign materials are mixed. When the valve body 31 is operated and the opening 29 is opened/closed, ink is circulated to the gaps of the windings of the coil spring 35 so that the foreign materials can be captured when the coil spring 35 is flexible and the foreign materials can be reliably captured even if minimal foreign materials are present.

Accordingly, the foreign materials can be captured in the gaps of the windings of the coil spring 35 even if the foreign materials are mixed from the supply passage 23 to the transporting passage 24 and the foreign materials can be easily captured in the inside of the sealing apparatus 22. Thus, the foreign materials are not pinched between the seal base 41 and the opening 29, the gaps are empty when the valve is closed so that ink is reliably prevented from being leaked in the transporting passage 24. Also, the foreign materials can be captured without providing the filter member in the sealing apparatus 22 and the number of the parts is not increased.

Since the coil spring 35 has a conical shape, the coil spring 35 is always flexible in the axial direction even in the case where the coil spring 35 is flexible when the valve body 31 is opened/closed, and the gaps of the windings are uniformly maintained in a circumferential direction so that the foreign materials can be reliably captured. Also, since the coil spring 35 is fitted between the protrusion member 32 and the cylindrical wall 28, the positioning can be reliably performed and the variation cannot occur during expansion and contraction. Also, the upstream valve shaft 43 comes into contact with the protrusion member 32 so that the contraction position of the coil spring 35 is defined, and the opening/closing of the valve body 31 can be performed smoothly by the biasing force of the coil spring 35.

In the above-described embodiment, the ink passage is configured such that the slit 33 is provided in the cylindrical wall 28 and the slit groove 34 is provided in the protrusion member 32, however the flow passage that communicates between the supply passage 23 and the inside of the coil spring 35 may be independently formed in the case. Also, a cylindrical coil spring may be used instead of a conical coil spring 35.

In the above-described embodiment, as an example of the liquid ejecting head, the description has been given regarding the ink jet type recording head, however the invention widely relates to objects that are general liquid ejecting heads and of course, may be applied even in liquid ejecting heads that eject liquid other than ink. For example, other liquid ejecting heads may include all kinds of recording heads that are used in an image recording apparatus such as a printer, a color material ejecting head that is used to manufacture a color filter such as a liquid crystal display, an organic EL display, an electrode material ejecting head that is used to form electrodes such as a FED (field emission display), and a bioorganic matter ejecting head that is used to manufacture a bio-chip.

What is claimed is:

1. A liquid ejecting head comprising:
a sealing apparatus and a head main body,
wherein the sealing apparatus includes a valve body that opens/closes a flow passage in which liquid is circulated, a biasing member that is arranged at an upstream side of the flow passage and biases the valve body toward a closing side, and a pressure member that pinches the valve body and opens/closes the valve body according to a change of a liquid pressure difference between the flow passage of the upstream side and the flow passage of a downstream side,
wherein the biasing member includes a circulation passage that circulates the liquid being circulated to the downstream side of the flow passage and is configured to capture foreign materials, and
wherein the head main body includes a nozzle opening that ejects liquid that is transported from the flow passage of the downstream side of the sealing apparatus.

2. The liquid ejecting head according to claim 1, wherein the biasing member is a coil spring and circulates the liquid from the inside to the outside of the coil spring so that the liquid is circulated to the downstream side of the flow passage and the foreign materials are captured in gaps between windings of the coil spring.

3. The liquid ejecting head according to claim 2, wherein the coil spring is a conical shape that a diameter thereof is gradually decreased in axial direction toward the valve body side.

4. The liquid ejecting head according to claim 3, wherein the valve body includes,
a seal base that closes off an opening of the flow passage from the upstream side,
a downstream valve shaft that is formed continuously to the downstream side of the seal base and is arranged so as to be penetrating the opening, and contacts the pressure member at a tip end, and
an upstream valve shaft that is formed continuously to the upstream side of the seal base and fitted to the inside portion of the coil spring,
wherein the flow passage of the upstream side is formed with a protrusion member to which the inside portion of the coil spring of the opposite side of the valve body is fitted,
wherein the flow passage of the upstream side is a passage for guiding the liquid to the inside portion of the coil spring from a side section of the protrusion member, and
wherein a cylindrical wall is fitted to the outside portion of the coil spring of which a portion is fitted to the protrusion member, and a circulation section that forms a portion of the passage that guides the liquid to the inside of the coil spring is formed at a portion of the cylindrical wall.

5. The liquid ejecting head according to claim 4, wherein the pressure member is a sheet material that is deformed when the liquid pressure of the flow passage of the downstream side is lowered relatively with respect to the liquid pressure of the upstream side and in which the downstream valve shaft is pressed and the seal base is separated from the opening against a biasing force of the coil spring so that the valve body is opened.

6. A liquid ejecting apparatus including the liquid ejecting head according to claim 1.
